(19) United States
(12) Patent Application Publication
(10) Pub. No.: US 2023/0319387 A1
(43) Pub. Date: Oct. 5, 2023

(54) WEARABLE CAMERA

(71) Applicant: CANON KABUSHIKI KAISHA, Tokyo (JP)

(72) Inventors: FUZUKI KASUYA, Kanagawa (JP); KENSUKE FUJITA, Tokyo (JP)

(21) Appl. No.: 18/189,003

(22) Filed: Mar. 23, 2023

(30) Foreign Application Priority Data
Mar. 31, 2022 (JP) 2022-061235

(51) Int. Cl. H04N 23/56; H04N 23/611; H04N 23/71; H04N 23/65; G03B 17/18

(52) U.S. Cl. CPC H04N 23/56; H04N 23/611; H04N 23/71; H04N 23/651; G03B 17/18

(57) ABSTRACT

A wearable camera includes an imaging unit, an irradiation unit that radiates light indicating an imaged portion to be imaged by the imaging unit, a processor, and a memory that stores instructions to be executed by the processor, wherein, when the stored instructions are executed, the wearable camera functions as a control unit that controls power to be supplied to the irradiation unit, and wherein the control unit controls the power to be supplied to the irradiation unit based on a state of an image acquired by the imaging unit.

### BACKGROUND

### Field

The present disclosure relates to a wearable camera including an irradiation unit, and in particular to control of an irradiation condition of the irradiation unit.

### Description of the Related Art

In recent years, a wearable camera has been well-known as an imaging apparatus that can be mounted on the body of a user. The wearable camera can capture an image in front and in back of the user while the user is in a hands-free state when the user wears the wearable camera on the user's neck, ear, or head, which enables the user to capture an image and work at the same time. In a case where an image is captured while the wearable camera is mounted on the user's neck, ear, or head, the user cannot grasp an accurate direction of the camera, and cannot know what image is being captured in some cases. An effective method in such a case is that the wearable camera has a pointer function to indicate an image to be captured and an imaging range. Japanese Patent Application Laid-Open No. 2018-54439 discusses a wearable camera including a pointer function that indicates an imaging range to a user. In the technique discussed in Japanese Patent Application Laid-Open No. 2018-54439, power consumption of the pointer as the irradiation unit is not considered

If the power consumption is not appropriately controlled, the power consumption can be increased. More specifically, even in a case where irradiation of the pointer is unnecessary or even in a case where irradiation of the pointer is not preferable, irradiation of the pointer can be continued. In such a case, a person wearing a wearable camera (hereinafter, simply referred to as wearer) can manually turn off the pointer. The wearable camera has an advantage that the wearer does not have to use hands when the wearer wears the wearable camera, so that the wearer can capture an image and work at the same time. For this reason, it is troublesome and not preferable that the wearer manually changes the irradiation state of the pointer.

The technique discussed in Japanese Patent Application Laid-Open No. 2018-54439 is based on the premise of being indoors, such as a manufacturing site. Brightness (illuminance) of light of the pointer is equivalent to or slightly lower than a guide value (about 1000 lux or less) of indoor illumination, and is sufficient. Accordingly, the wearer can easily visually recognize the irradiation light of the pointer. However, when the pointer function is used outdoors under sunlight (about 1000 lux to about 100000 lux), the wearer may not visually recognize the irradiation light of the pointer because the brightness (illuminance) of the pointer is less than the sunlight. When the output of the pointer is simply increased to enable the wearer to visually recognize the irradiation light, the power consumption is increased, and a battery life of the wearable camera can be shortened. Increase in power consumption increases a temperature at a portion near the pointer and at a portion of the camera in contact with the wearer's skin. To radiate heat, it is necessary to mount a cooling fan or to increase a surface area at the portion near the pointer, which leads to concern about increasing the size of the wearable camera.

### SUMMARY

According to an aspect of the present disclosure, a wearable camera includes an imaging unit, an irradiation unit configured to radiate light indicating an imaged portion to be imaged by the imaging unit, a processor, and a memory configured to store instructions to be executed by the processor, wherein, when the stored instructions are executed, the wearable camera functions as a control unit configured to control power to be supplied to the irradiation unit, and wherein the control unit controls the power to be supplied to the irradiation unit based on a state of an image acquired by the imaging unit.

Further features will become apparent from the following description of exemplary embodiments with reference to the attached drawings.

### BRIEF DESCRIPTION OF THE DRAWINGS

FIG. 1 illustrates an appearance of a wearable camera according to exemplary embodiments.

FIG. 2 is a block diagram illustrating a configuration example of a wearable camera according to a first exemplary embodiment.

FIG. 3 is a flowchart illustrating an example of processing for controlling the wearable camera according to the first exemplary embodiment.

FIG. 4 is a block diagram illustrating a configuration example of a wearable camera according to a second exemplary embodiment.

FIG. 5 is a flowchart illustrating an example of processing for controlling the wearable camera according to the second exemplary embodiment.

FIG. 6 is a block diagram illustrating a configuration example of a wearable camera according to a third exemplary embodiment.

FIG. 7 is a flowchart illustrating an example of processing for controlling the wearable camera according to the third exemplary embodiment.

FIG. 8 is a flowchart illustrating an example of processing for controlling a wearable camera according to a fourth exemplary embodiment.

### DESCRIPTION OF THE EMBODIMENTS

Some exemplary embodiments are described in detail with reference to accompanying drawings. The exemplary embodiments described below are not seen to be limiting according to the claims. A plurality of features is described in the exemplary embodiments. However, all of the plurality of features are not necessarily essential, and the plurality of features may be optionally combined. In the accompanying drawings, the same or similar components are denoted by the same reference numerals, and repetitive description is omitted.

An aspect of a first exemplary embodiment, is directed to a wearable camera that can appropriately control power consumption without troubling the wearer by automatically turning off a pointer in a case where irradiation of the pointer is unnecessary based on a state of a captured image.

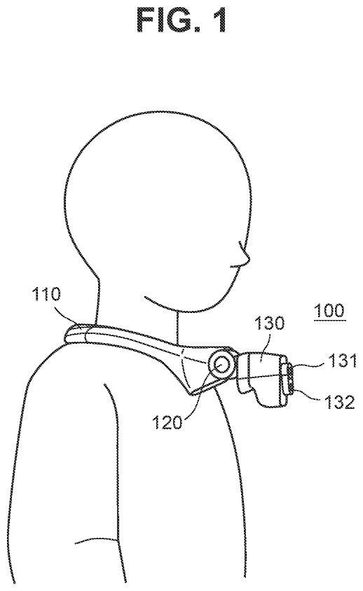

Pointer irradiation control of the wearable camera according to the first exemplary embodiment is described with reference to FIG. 1 to FIG. 3.

FIG. 1 illustrates an appearance of a wearable camera 100 according to the exemplary embodiments. The wearable camera 100 includes a mounting portion 110, a movable portion 120, and a camera head portion 130. The wearer uses the wearable camera 100 by hanging the mounting portion 110 from the user's neck. The camera head portion 130 includes an imaging unit 131 and a pointer unit 132 as an irradiation unit. The imaging unit 131 captures an image of in front of the user, where the pointer unit 132 indicates an imaged portion to be imaged by the imaging unit 131 to the wearer. The movable portion 120 is located between the mounting portion 110 and the camera head portion 130, and rotates the camera head portion 130.

In the present exemplary embodiment, the imaging unit 131 and the pointer unit 132 are located inside the same camera head portion 130. This arrangement is not limited to the presently described configuration as long as the pointer unit 132 can indicate the imaged portion. In a case where a wearable camera does not require a rotation mechanism of the camera head portion 130, the movable portion 120 can be eliminated, and the mounting portion 110 and the camera head portion 130 can be directly connected. The wearable camera 100 is not limited to a mode where the wearer uses the wearable camera 100 by hanging the mounting portion 110 from the user's neck as long as the wearable camera 100 can be mounted on a part of the user's body in a hands-free manner. Since a user's neck is typically not shaken much by the user's motion, a neck hanging camera is barely influenced by operation of the wearer and can stably capture an image as the wearable camera.

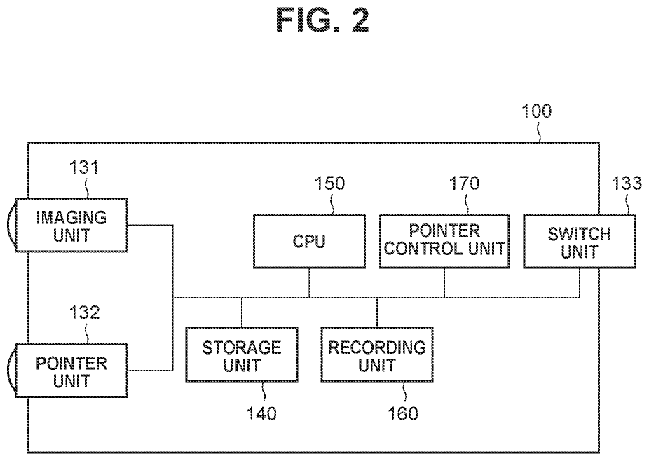

FIG. 2 is a block diagram illustrating a configuration example of the wearable camera 100 according to the first exemplary embodiment.

The imaging unit 131 includes an imaging element and an imaging lens (both not illustrated). The imaging element includes a charge-coupled device (CCD) element or a complementally metal-oxide semiconductor (CMOS) element, and an analog-to-digital (A/D) converter. An optical image is formed on the CCD element or the COMS element through the imaging lens. The CCD element or the CMOS element outputs an electric signal (analog signal) corresponding to the optical image, and the A/D converter converts the analog signal into a digital signal, and outputs the digital signal as image data. Configurations of the imaging lens, the imaging element, and the A/D converter included in the imaging unit 131 are not limited, and various kinds of well-known configurations are adoptable. In other words, it is sufficient for the imaging unit 131 to generate the electric signal (image data) from the optical image of an object and to output the electric signal.

The pointer unit 132 indicates the imaged portion to the wearer of the wearable camera 100. The pointer unit 132 includes a pointer light source (not illustrated). The pointer light source is, for example, a semiconductor laser (LD) or a light-emitting diode (LED) element. In a case where the light source is the LED element, a condenser lens is desirably disposed in front of the LED element to narrow a light distribution angle because the LED element is wider in light distribution angle than the semiconductor laser. The point light source can easily indicate the imaged portion without including a mechanism for narrowing the above-described light distribution angle and the like.

In the present embodiment, the pointer unit 132 irradiates light at one point within the imaging range. The pointer unit 132 irradiates the center of the imaging range, but can irradiate portions other than the center of the imaging range. In addition, a lens with a large light distribution angle can be used to irradiate a wide area within the imaging range if it does not interfere with imaging.

A storage unit 140 is an electrically erasable/recordable memory, a system memory, a work memory, and an image memory, and includes a random access memory (RAM) and a read only memory (ROM). The storage unit 140 stores constants, programs, and the like for operation of a central processing unit (CPU) 150. The programs include programs to execute processing in a flowchart described below. More specifically, the RAM included in the storage unit 140 temporarily stores computer programs executed by the CPU 150. The RAM can provide a work area to be used when the CPU 150 performs processing. The RAM can function as a frame memory and a buffer memory. The ROM included in the storage unit 140 stores programs and the like for the CPU 150 to control the wearable camera 100.

The CPU 150 is a central processing device for controlling the wearable camera 100. The CPU 150 performs processing to be described below by executing the programs recorded in the storage unit 140. The CPU 150 transmits image data recorded in the storage unit 140 to a recording unit 160, and records the image data in the recording unit 160. The recording unit 160 is a recording medium such as a memory card. A pointer control unit 170 controls power supplied to the pointer unit 132 based on the program executed by the CPU 150, and supplies power to the pointer unit 132.

A switch unit 133 is located on an exterior of the mounting portion 110 or the camera head portion 130. When the switch unit 133 is physically depressed, the pointer unit 132 is switched on or off. A state where the pointer unit 132 is ON indicates a state where power can be supplied from the pointer control unit 170 to the pointer unit 132. A state where the pointer unit 132 is OFF indicates a state where power cannot be supplied from the pointer control unit 170 to the pointer unit 132. When the switch unit 133 is depressed once in the state where the pointer unit 132 is OFF, the pointer unit 132 is switched on. When the switch unit 133 is depressed again in the state where the pointer unit 132 is ON, the pointer unit 132 is switched off.

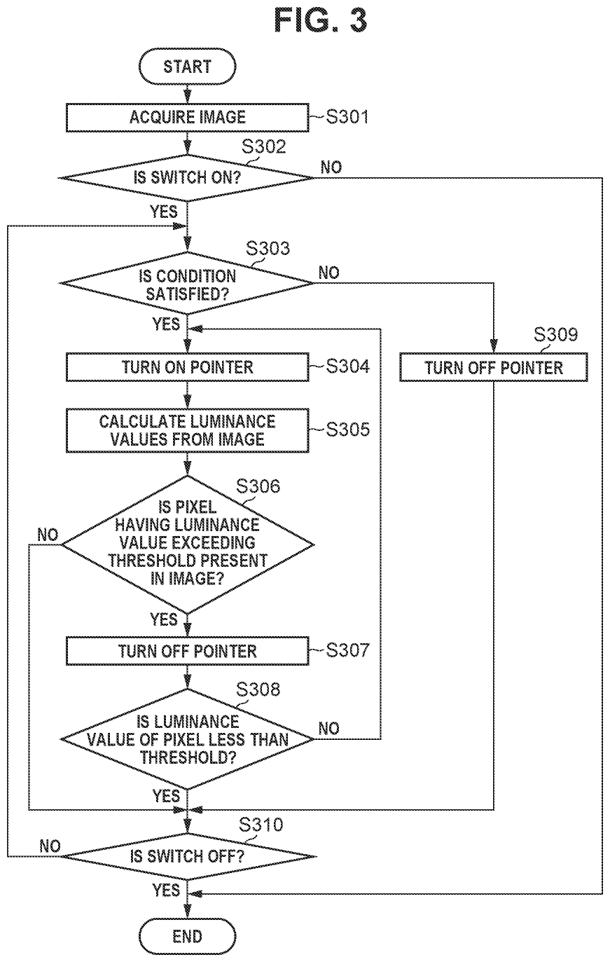

A procedure of controlling an irradiation state of the pointer unit 132 based on the state of the captured image is described in detail with reference to a flowchart illustrated in FIG. 3.

FIG. 3 is a flowchart illustrating an example of processing for controlling the wearable camera 100 according to the first exemplary embodiment. The processing in the flowchart of FIG. 3 is performed when the CPU 150 operating in the wearable camera 100 executes the programs stored in the storage unit 140.

When the wearable camera 100 starts to capture an image, the imaging unit 131 acquires an image in step S301. In step S302, the CPU 150 determines an ON/OFF state of the pointer unit 132 from a depression state of the switch unit 133. In a case where the pointer unit 132 is OFF (NO in step S302), the processing ends without performing any subsequent processing. In a case where the pointer unit 132 is ON (YES in step S302), the CPU 150 determines in step S303 whether a condition described below is satisfied based on a captured image acquired in step S301. In a case where the state of the captured image does not satisfy the condition (NO in step S303), the pointer control unit 170 interrupts power supply to the pointer unit 132 in response to an instruction from the CPU 150 in step S309, and the processing proceeds to step S310.

In a case where the state of the captured image satisfies the condition (YES in step S303), the pointer control unit 170 supplies power to the pointer unit 132 in response to an instruction from the CPU 150 in step S304. In a case where the condition that there is no person in the captured image is satisfied, the pointer unit 132 is turned on in step S304.

The condition in step S303 is, for example, that there is no person in the captured image, as a result of detecting a human body in the captured image acquired in step S301. In other words, in step S303, the CPU 150 determines the state of the captured image.

In step S305, the CPU 150 calculates a luminance value for each pixel from the captured image acquired in step S301. In step S306, the CPU 150 determines whether a pixel having a luminance value exceeding a certain threshold is present. In a case where there is no pixel in the image having a luminance value exceeding the threshold (NO in step S306), the processing proceeds to step S310. In a case where a pixel having a luminance value exceeding the threshold is present (YES in step S306), the pointer control unit 170 interrupts power supply to the pointer unit 132 in response to an instruction from the CPU 150 in step S307. In step S308, the imaging unit 131 acquires an image again, and the CPU 150 determines whether the luminance value of the pixel determined to have the luminance value exceeding the threshold in step S306 is less than the threshold. In a case where the luminance value of the pixel is less than the threshold (YES in step S308), the processing proceeds to step S310.

In step S310, the CPU 150 again determines the ON/OFF state of the pointer unit 132 from the depression state of the switch unit 133. In a case where the pointer unit 132 is OFF (YES in step S310), the processing ends. In a case where the pointer unit 132 is ON (NO in step S310), the processing returns to step S303, and the processing from step S303 to step S310 is repeated until the pointer unit 132 is physically turned off.

By performing the pointer irradiation control per the above-described flow illustrated in FIG. 3, the wearable camera 100 automatically turns off the pointer unit 132 in a case where it is determined that irradiation of the pointer unit 132 is unnecessary. In particular, in the loop processing from step S304 to step S308, the irradiation light from the pointer unit 132 can be reflected by an object, and reflected light can be reflected on the captured image. In this case, the luminance values can increase at a part of the captured image, and quality and visibility of the image can be deteriorated. In this case, the pointer unit 132 is also turned off.

The above-described processing enables the wearable camera 100 to reduce unnecessary power consumption and appropriately control power consumption without troubling the wearer. The processing from step S304 to step S308 can prevent deterioration of image quality and visibility.

As described above, for example, a human body is detected in the captured image acquired in step S301, and absence of a person in the captured image is used as the condition.

Based on the condition, the pointer unit 132 is automatically turned off in the case where a person is detected in the captured image. Thus, power consumption can be appropriately controlled. In addition, safety can also be obtained since, for example, turning off the pointer unit 132 results in preventing the pointer unit 132 from irradiating a detected person's eyes. An example of detecting a human body includes, but is not limited to, moving object detection using background difference. Any method enabling detection of a human body that enables practice of the above-described processing is applicable.

Another condition applicable for the determination in step S303 can be whether the wearer of the wearable camera 100 is performing any work. In this case, when the pointer unit 132 is turned on by depression of the switch unit 133 but the wearer is not performing any work, the pointer unit 132 is turned off to reduce power. It can be determined whether the wearer is performing any work, for example, by detecting hands or arms of the wearer from the captured image acquired by the imaging unit 131 and determining whether the hands or arms are within an angle of view for a predetermined time or more. This determination method is not seen to be limiting. In addition to the above-described determination conditions, the determination in step S306 is optional, and any one or more of the conditions can be determined.

Aspects of a second exemplary embodiment are directed to, a wearable camera that adjusts power and controls blinking of the pointer unit 132 based on the brightness of the captured image to suppress power consumption to an appropriate power consumption.

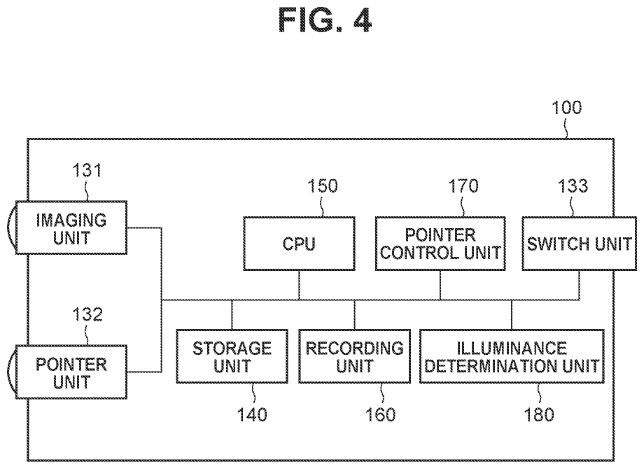

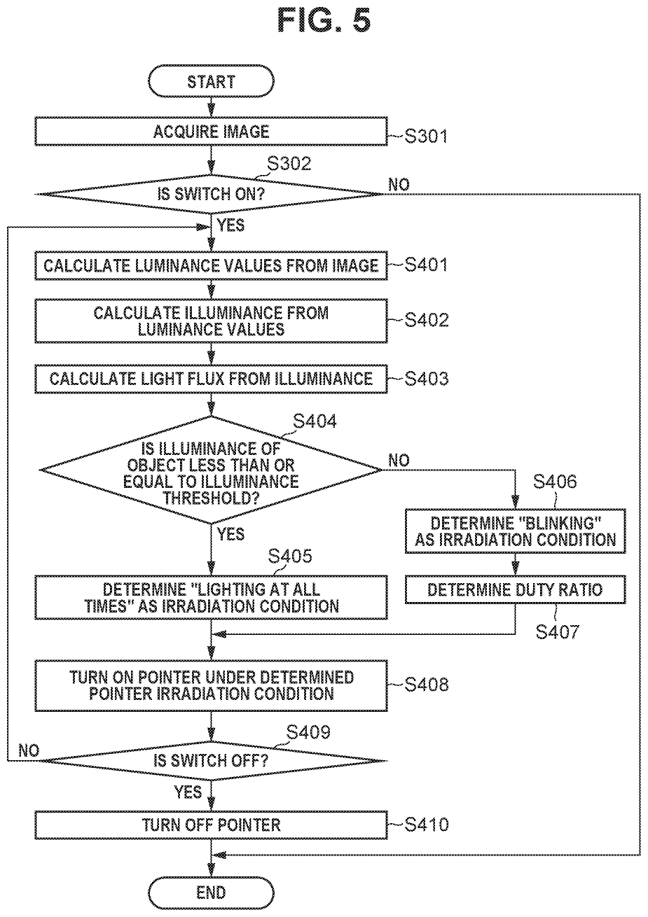

The wearable camera that adjusts power and controls blinking of the pointer unit 132 based on the brightness of the captured image according to the second exemplary embodiment is described in detail with reference to FIG. 4 and FIG. 5.

FIG. 4 is a block diagram illustrating a configuration example of the wearable camera 100 according to the second exemplary embodiment. Description of components similar to the components in the first exemplary embodiment is omitted. The wearable camera 100 according to the second exemplary embodiment includes an illuminance determination unit 180. The illuminance determination unit 180 determines illuminance of an object from luminance of the captured image acquired by the imaging unit 131. Correlation between the luminance and the illuminance is previously stored in the storage unit 140.

The pointer control unit 170 supplies power to the pointer unit 132 as described above with respect to the first exemplary embodiment. The pointer control unit 170 can adjust an amount of power to be supplied based on the illuminance of the object calculated (determined) by the illuminance determination unit 180. For example, in a case where it is determined that the illuminance of the object is low, the amount of power supplied from the pointer control unit 170 is reduced. In a case where it is determined that the illuminance of the object is high, a large amount of power is supplied. A light flux and the power consumption of the light source can be calculated from the illuminance of the object, and correlation is previously stored in the storage unit 140.

The power adjustment and the blinking control of the pointer unit 132 based on the brightness of the captured image are described with reference to FIG. 4 and FIG. 5.

FIG. 5 is a flowchart illustrating an example of processing for controlling the wearable camera 100 according to the second exemplary embodiment. The processing in the illustrated flowchart is performed when the CPU 150 operating in the wearable camera 100 executes the programs stored in the storage unit 140.

When the processing starts, the imaging unit 131 acquires an image in step S301. When the wearer depresses the switch unit 133 (YES in step S302), the illuminance determination unit 180 calculates (determines) luminance values from the acquired image in step S401. In step S402, the illuminance of the object is calculated from the calculated luminance values. As described above, the illuminance of the object is calculated (determined) from the correlation with the luminance previously stored in the storage unit 140. After the illuminance of the object is calculated, the CPU 150 calculates a value of a light flux necessary to enable the wearer to visually recognize the irradiation light on the object in step S403. The value of the light flux has proportional relationship with the brightness of the object. Accordingly, adjustment is performed such that the value of the light flux is increased when the object is bright.

In step S302, in a case where the wearer does not depress the switch unit 133 (NO in step S302), the processing ends without performing the subsequent processing.

The irradiation state of the pointer unit 132 is determined based on the illuminance of the object calculated in step S402. An illuminance threshold as a boundary between bright illuminance and dark illuminance of the object is previously determined. In this example, the illuminance threshold is set to, for example, 1000 lux that is the above-described guide value of the indoor illumination. In step S404, it is determined whether the illuminance of the object calculated in step S402 is less than or equal to the illuminance threshold. In a case where it is determined that the illuminance of the object is less than or equal to the illuminance threshold (YES in step S404), “lighting at all times” is determined as the irradiation condition of the pointer unit 132 in step S405. In a case where it is determined that the illuminance of the object is greater than the illuminance threshold (NO in step S404), the CPU 150 determines “blinking” as the irradiation condition in step S406. The irradiation condition is set to blinking to suppress the power consumption as compared with lighting at all times while the light radiated from the pointer unit 132 is visually recognized by the wearer. After blinking is determined as the irradiation condition, a duty ratio of on/off time in blinking is determined in step S407. The pointer control unit 170 calculates the duty ratio by dividing an average value of the power consumption to be finally supplied by the power consumption necessary for lighting at all times. For example, in a case where the pointer unit 132 is lit at all times with the light flux calculated in step S403, the power consumption is 2 W. In a case where the pointer control unit 170 determines to suppress the power consumption to 0.5 W on average by blinking, the duty ratio is calculated as 0.5 W/2 W×100=25%. Accordingly, in this case, blinking in which 25% of a time in a period is ON and remaining 75% of the time is OFF is performed.

Control up to turning-off of the pointer unit 132 will be described with respect to step S410. After the irradiation condition of the pointer unit 132 is determined, the pointer control unit 170 controls the pointer unit 132 under the determined irradiation condition in step S408, and the pointer unit 132 is turned on. Thereafter, until the wearer depresses the switch unit 133 again, the CPU 150 repeats the processing from step S401 to step S409 (NO in step S409). In a case where the wearer depresses the switch unit 133 again (YES in step S409), the pointer unit 132 is turned off in step S410, and the processing ends.

In the present exemplary embodiment, it is determined whether the irradiation condition is set to lighting at all time or blinking based on the illuminance of the object. In another exemplary embodiment in a case where the illuminance of the object is less than or equal to the illuminance threshold, determination processing proceeding to step S406 can be added between step S404 and step S405 in consideration of lifetime of a battery in order to lengthen the lifetime of the battery.

In the present exemplary embodiment, the illuminance of the object is detected from the captured image acquired by the imaging unit 131. In another exemplary embodiment, an illuminometer can be included inside the wearable camera, and the wearable camera can detect the illuminance of the object from both of the captured image and the illuminometer.

In the second exemplary embodiment, the CPU 150 performs the control illustrated in FIG. 5 so that the wearer can visually recognize the light radiated from the pointer unit 132 on the object, regardless of the illuminance of the object. Because the wearable camera 100 radiates the light of the pointer unit 132 with the appropriate power consumption, it is possible to maintain long battery lifetime.

A third exemplary embodiment will now be described. The second exemplary embodiment described a wearable camera where the pointer control unit 170 adjusts the power and controls the blinking of the pointer unit 132 based on the brightness of the captured image to suppress the power consumption to the appropriate power consumption. The third exemplary embodiment is directed to, a wearable camera that includes a temperature detection unit and controls a continuous irradiation time of the pointer unit 132 based on the brightness of the captured image and a temperature acquired by the temperature detection unit. Processing for controlling the irradiation time is performed to suppress the power consumption to the appropriate power consumption and to prevent influence of heat on the wearable camera and the wearer.

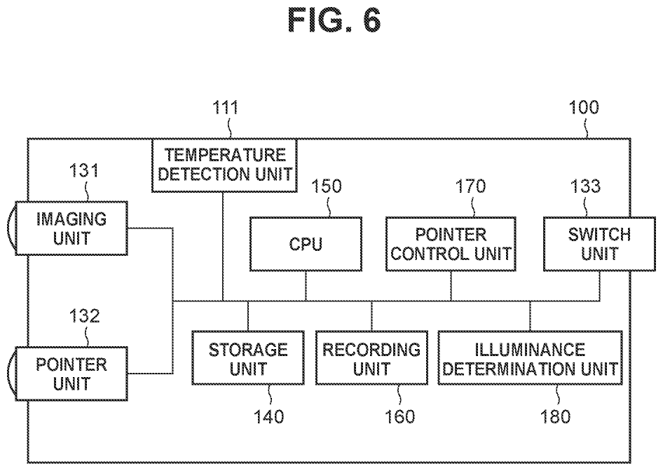

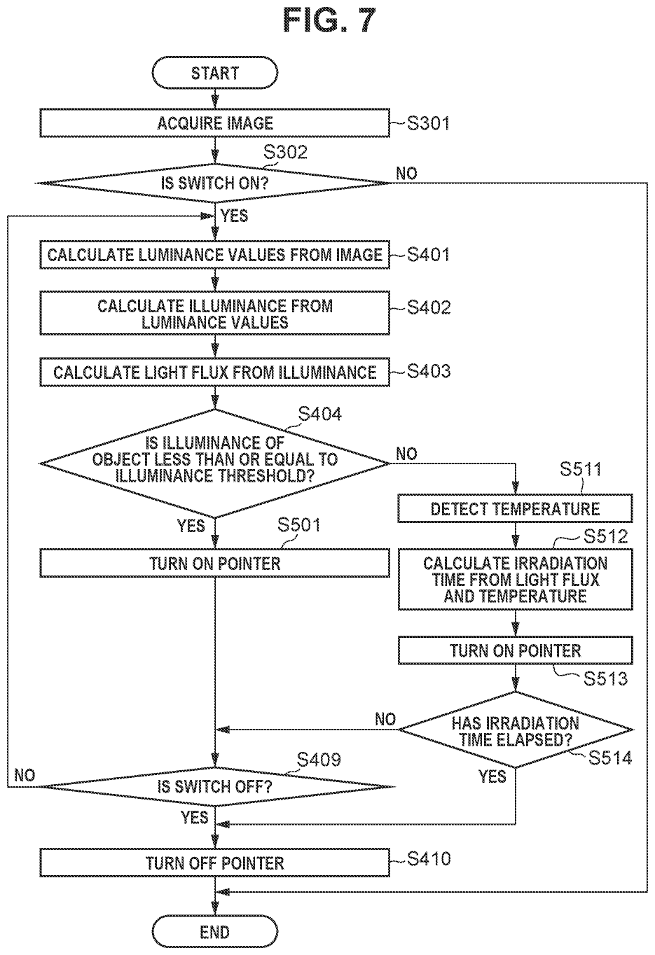

The wearable camera that adjusts the power and controls the continuous irradiation time of the pointer unit 132 based on the brightness of the object and the temperature according to the third exemplary embodiment is described with reference to FIG. 6 and FIG. 7.

FIG. 6 is a block diagram illustrating a configuration example of the wearable camera 100 according to the third exemplary embodiment. Description of components similar to the components in the second exemplary embodiment is omitted. The wearable camera 100 according to the third exemplary embodiment includes a temperature detection unit 111. The temperature detection unit 111 includes a temperature sensor (not illustrated). At least one temperature detection unit 111 is located at a portion of the mounting portion 110 or the camera head portion 130 in contact with the body of the wearer where temperature correlation with the portion in contact with the body is obtainable. The temperature detection unit 111 constantly detects a temperature in imaging, while the pointer control unit 170 controls irradiation of the pointer unit 132 as described below based on the temperature.

FIG. 7 is a flowchart illustrating an example of processing for controlling the wearable camera 100 according to the third exemplary embodiment. The processing in the illustrated flowchart is performed when the CPU 150 operating in the wearable camera 100 executes the programs stored in the storage unit 140.

The processing in steps S301 and S302 and steps S401 to S404 are similar to the processing in the second exemplary embodiment. Determination and control of the continuous irradiation time after step S404 are different. In a case where the illuminance of the object is less than or equal to the illuminance threshold (YES in step S404), a time limit is not particularly provided. In step S501, the pointer control unit 170 turns on the pointer unit 132 with the light flux calculated in step S403. When the switch unit 133 is depressed (YES in step S409), the pointer control unit 170 turns off the pointer unit 132 in step S410.

In a case where the illuminance of the object is greater than the illuminance threshold (NO in step S404), the pointer control unit 170 performs processing based on the irradiation time calculated from the light flux and the temperature in steps S511 to S514.

In step S511, the temperature detection unit 111 acquires a temperature. In step S512, the temperature detection unit 111 calculates (determines) the irradiation time of the pointer unit 132 based on the temperature and the light flux calculated in step S403. The irradiation time is, for example, a time until the detected temperature exceeds a predetermined temperature threshold. The time until the detected temperature exceeds the temperature threshold can be calculated (determined) when the temperature and the light flux are determined. The temperature threshold is a value previously stored in the storage unit 140, and for example, a temperature where influence of heat on skin can be prevented can be set as the temperature threshold.

In step S513, the pointer control unit 170 turns on the pointer unit 132 only for the irradiation time calculated in step S512. After the irradiation time has elapsed (YES in step S514), the pointer unit 132 is automatically turned off regardless of ON/OFF status of the switch unit 133 in step S410. In a case where the wearer depresses the switch unit 133 before the predetermined irradiation time elapses (NO in step S514 and YES in step S409), the pointer unit 132 is turned off. The brightness of the object can be varied before the switch unit 133 is depressed. The CPU 150 repeats the processing in steps S401 to S404 and steps S501 to S514 (NO in step S409) to constantly maintain the optimum irradiation condition of the pointer unit 132.

In the present exemplary embodiment illustrated in FIG. 7, the irradiation time is determined based on the light flux of the pointer unit 132 and the temperature acquired by the temperature detection unit 111. In another exemplary embodiment, the irradiation time can be calculated from the light flux of the pointer unit 132 and the lifetime of the battery contained in the wearable camera 100. In a case where the illuminance of the object is greater than the illuminance threshold, the maximum continuous irradiation time can be uniformly determined up to, for example, three seconds.

In the third exemplary embodiment, the CPU 150 performs the control illustrated in FIG. 7 so that the wearer can visually recognize the light radiated from the pointer unit 132 on the object, regardless of the illuminance of the object. The irradiation time is set based on the temperature acquired by the temperature detection unit 111 and the light flux calculated from the image to suppress the power consumption to the appropriate power consumption, and to prevent influence of heat on the wearable camera and the wearer.

A fourth exemplary embodiment will now be described. In the first to third exemplary embodiments, the method of controlling the irradiation state of the pointer unit 132 based on the state of the captured image acquired by the imaging unit 131 is described. The present exemplary embodiment describes a method of controlling the irradiation state of the pointer unit 132 based on a state of the wearable camera 100 regardless of the captured image acquired by the imaging unit 131.

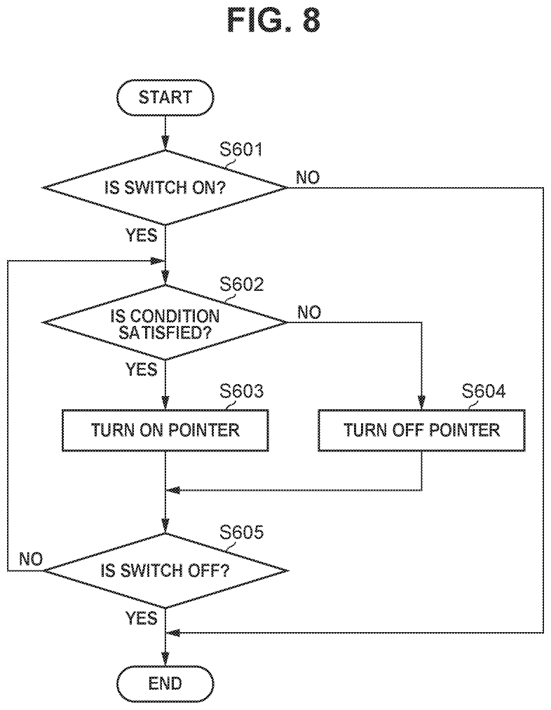

Pointer irradiation control of the wearable camera 100 according to the fourth exemplary embodiment will be described with reference to FIG. 8.

The processing in the flowchart of FIG. 8 is performed when the CPU 150 operating in the wearable camera 100 executes the programs stored in the storage unit 140. Processing in steps S601 to S605 illustrated in FIG. 8 is similar to the processing in steps S302 to S310 illustrated in FIG. 3, excluding steps S305 to S308. The determination condition in step S602 is different from the determination condition in step S303 described in the first exemplary embodiment.

For example, as the determination condition in step S602, it is determined whether the wearable camera 100 has been mounted on a human body. In other words, in a case where the wearable camera 100 has been mounted on a human body, the pointer unit 132 is turned on in step S603. In this case, when the pointer unit 132 is turned on by depression of the switch unit 133 but the wearable camera 100 has not been mounted on a human body, the pointer unit 132 is turned off regardless of the state of the captured image. This enables preventing unnecessary power consumption. It can be determined whether the wearable camera 100 has been mounted on a human body by, for example, providing a sensor in the mounting portion 110. However, the determination method is not limited to the above-described example.

Another example as the condition in step S602, it can be determined whether the wearable camera 100 is capturing or recording an image. In other words, in a case where the wearable camera 100 is capturing or recording an image, the pointer unit 132 is turned on in step S603. It can be determined whether the wearable camera 100 is capturing or recording an image, for example, based on whether writing is being newly performed on the recording unit 160. The determination method is not limited to the above-described example. In another exemplary embodiment, the remaining amount of the battery for driving the wearable camera 100 can be monitored, and it can be determined whether the remaining amount is not less than a certain threshold, as the condition in step S602. In other words, in a case where the remaining amount of the battery of the wearable camera 100 is greater than or equal to the certain threshold, the pointer unit 132 is turned on in step S603. As described in the third exemplary embodiment, the wearable camera 100 can be provided with the temperature detection unit, and it can be determined whether the detected temperature does not exceed a certain threshold, as the condition in step S602. In other words, in a case where the temperature of the wearable camera 100 is less than or equal to the certain threshold, the pointer is turned on in step S603. In this case, the pointer unit 132 is automatically turned off in a case where the temperature exceeds the certain temperature, so that the power consumption can be appropriately controlled. In addition, it is possible to prevent temperature increase more than necessary by pointer irradiation, and to enhance safety of the wearable camera directly in contact with a human body. For example, in a case where the wearable camera 100 can communicate with a communication partner at a remote location via a wireless network, it can be determined whether an instruction to turn off the pointer unit 132 has not been received from a communication partner at the remote location, as the condition in step S602. In other words, in a case where the wearable camera 100 has not received the instruction to turn off the pointer unit 132 from the communication partner at the remote location, the pointer unit 132 is turned on in step S603. The plurality of determination conditions is not essential, and one or more of the conditions can be determined.

The above-described processing enables the wearable camera 100 to reduce unnecessary power and appropriately control power consumption based on its state without troubling the wearer.

Although exemplary embodiments are described above, these embodiments are not seen to be limiting, and can be variously modified and changed within the gist of the present disclosure.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, these embodiments are not seen to be limiting. The scope of the following claims is to be accorded the broadest interpretation so as to encompass all such modifications and equivalent structures and functions.

This application claims the benefit of Japanese Patent Application No. 2022-061235, filed Mar. 31, 2022, which is hereby incorporated by reference herein in its entirety.

1. A wearable camera comprising:
an imaging unit;
an irradiation unit configured to radiate light indicating an imaged portion to be imaged by the imaging unit;
a processor; and
a memory configured to store instructions to be executed by the processor,
wherein, when the stored instructions are executed, the wearable camera functions as a control unit configured to control power to be supplied to the irradiation unit, and
wherein the control unit controls the power to be supplied to the irradiation unit based on a state of an image acquired by the imaging unit.

2. The wearable camera according to claim 1, wherein, in a case where it is detected that a person is present in the image, the control unit does not supply power to the irradiation unit.

3. The wearable camera according to claim 1, wherein, in a case where a luminance value of the image exceeds a threshold due to reflected light by irradiation of the irradiation unit, the control unit does not supply power to the irradiation unit.

4. The wearable camera according to claim 1, wherein the control unit controls an irradiation state of the irradiation unit based on brightness of an object detected from the image.

5. The wearable camera according to claim 1, wherein the control unit performs control to repeatedly turn on and off the irradiation unit.

6. The wearable camera according to claim 1, wherein the control unit sets an irradiation time of the irradiation unit.

7. The wearable camera according to claim 6, further comprising a temperature detection unit,
wherein the irradiation time of the irradiation unit is a time until a temperature acquired by the temperature detection unit exceeds a preset temperature threshold.

8. A wearable camera comprising:
an imaging unit;
an irradiation unit configured to radiate light indicating an imaged portion to be imaged by the imaging unit;
a processor; and
a memory configured to store instructions to be executed by the processor,
wherein, when the stored instructions are executed, the wearable camera functions as a control unit configured to control power to be supplied to the irradiation unit, and
wherein the control unit controls the power to be supplied to the irradiation unit based on a state of the imaging unit.

9. The wearable camera according to claim 8, further comprising a temperature detection unit,
wherein, in a case where a temperature acquired by the temperature detection unit exceeds a threshold, the control unit does not supply power to the irradiation unit.

10. The wearable camera according to claim 1, wherein the irradiation unit is a point light source.

11. The wearable camera according to claim 1, wherein the wearable camera hangs from a neck of a user.

12. A method of controlling a wearable camera, the wearable camera including an imaging unit and an irradiation unit configured to radiate light indicating an imaged portion to be imaged by the imaging unit, the method comprising:
determining a state of an image acquired by the imaging unit; and
controlling power to be supplied to the irradiation unit based on the determined state of the image.

13. A non-transitory computer-readable storage medium configured to store a computer program for causing a wearable camera including an imaging unit and an irradiation unit configured to radiate light indicating an imaged portion to be imaged by the imaging unit to execute a method, the method comprising:
determining a state of an image acquired by the imaging unit; and
controlling power to be supplied to the irradiation unit based on the determined state of the image.
